(19) United States
(12) Patent Application Publication
(10) Pub. No.: US 2007/0253615 A1
(43) Pub. Date: Nov. 1, 2007

(54) Method and system for banknote recognition

(76) Inventors: Yuan-Hsiang Chang, Tao-Yuan (TW); Ya-Wen Chiang, Tao-Yuan (TW); Yo-Chen Wang, Tao-Yuan County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/410,923

(22) Filed: Apr. 26, 2006

(51) Int. Cl. G06K 9/00

(52) U.S. Cl. 382/135

(57) ABSTRACT

A system and a method for banknote recognition are provides. The connected components within a source image are detected when the source image is generated. Then the connected components are used for matching the prototypes in a database for selecting the corresponding best matched prototypes. The connected components will be determined as a first surface or a second surface for representing a banknote according to its best matched prototype. If it is determined as a first surface, the treasury seal recognition and signature recognition will be performed. Finally, the recognition of the image representing a currency value will be performed for determining whether it is a image representing a banknote or not.

### BACKGROUND OF THE INVENTION

1. Field of the Invention

The present invention generally relates to image recognition, and more particularly to the banknote recognition.

2. Description of the Prior Art

Nowadays, many scanners, faxes, a Xerox machines, or photocopiers may be used for generating an almost real image of a banknote. It also means that a counterfeit banknote may be printed according to said almost real image. If the image of a banknote can be detected when it is scanned, many precautions can be adapted. For example, invisible pixels or image can be marked on the image for tracking back or break the original image.

Therefore, the skills for banknote recognition will be very useful in the above progress. A banknote has many features on its front surface or back surface. The features can be the dimension, including the border 11 and the interior border 12, the color, the treasury seal 13, the images for representing the currency value 14, the images for representing the signature 15, and the images for representing the serial number 16, referring to FIG. 1A.

Referring to FIG. 1B. The banknote recognition can be started by matching the dimension of the image of a banknote, referring to step 110. Then the color of the banknote may be matched, referring to step 120. Next, some specific portions of the image will be matched with the other predefined features, referring to step 130. Finally, the step 140 determines whether it is a image of a banknote or not according to the result of the previous steps.

However, the banknote could be presented at anywhere of the image when it is scanned. It could be oblique and inverted. Besides, it may be the front surface or the back surface. The work contains not only the banknote recognition, but also the banknote detection and progress for centrally locating the image of banknote. Therefore, more skills need to be used in the previous problem.

### SUMMARY OF THE INVENTION

The present invention provides a method and system for banknote recognition. In the present invention, a database with a plurality of prototypes is provided. Each prototype has the information of a banknote. For examples, a banknote can be scanned or photographed for generating a prototype. The information could include the information of the front image, the back image, the feature values, and the signature. When a source image with a rectangle image which could be an image representing a banknote is inputted, the rectangle can be retrieved for advanced recognition by the present invention.

There may be a plurality of components in the source image and many of them are overlapped. Therefore the image of each component must be separated firstly. In one embodiment of the present invention, the connecting component method (Computer and Robot Vision Voulume1, p. 28-p. 33) can be applied. After component separation, the rectangle images can be retrieved for banknote recognition. Considering to the performance, we can choose a number of component images according to the dimension for banknote recognition.

The prototype can be generated from a front image, a back image, or both. Namely, the prototype contains the information representing the banknote. Therefore, the prototype can be a set of a lot of kinds of the information. In one embodiment of the present invention, a prototype contains only one of the front image and the back image.

There are a lot of kinds of banknotes. Each banknote has its own dimension, front image, and back image. Although it is possible that two different banknotes have the same dimension, the images of different kinds of banknotes should have different images. In the present invention, one or more prototypes which have the similar dimension would be retrieved for banknote recognition. Namely, the retrieved prototypes are not all prototypes in the database. Of course, in another embodiment of the present invention, all prototypes can be retrieved for banknote recognition.

After retrieving, the rectangle image is configured within a two-dimension space. The rectangle image could be oblique in proportion to the axis. Besides, it could be inverted. Thus, the position and direction of the rectangle image should be determined before recognition. That is, the rectangle image needs to be rotated and centrally located. There could be an included angle between the axis and the edges of the rectangle image. Therefore the rectangle image should be rotated through the included angle and aligned to the vertical axis and the horizontal axis. For instance, the rectangle image is left aligned to the vertical axis and bottom aligned to the horizontal axis.

Furthermore, the rectangle image may be inverted. If the rectangle image is inverted, it needs to be rotated through 180 degree rotation. It means that the rectangle image still needs to be determined whether it is inverted or not. The simplest way is to find out a best matched prototype for comparing with the rectangle image. The detail for finding the best matched prototype will remain to be discussed later.

According to one embodiment of the present invention, the best matched prototype could have the information of a treasury seal or a comparison result of two different portions of the rectangle image. The information of the treasury seal may include the image and the predefined position specified by the prototype. If the best matched prototype specified the information of a treasury seal, the recognition of the treasury seal in the rectangle image is performed. If it doesn't, the comparison result will be applied. According the position of the treasury seal, the rectangle image can be determined whether it is inverted or not. For examples, the rectangle image is inverted if the position of the treasury seal is not in a predefined position specified by the best matched prototype. Oppositely, the rectangle image is not the image of a banknote if the best matched prototype has the information of a treasury seal and the treasury seal can not be found in the rectangle image.

According to the information of the treasury seal, a color filtered image of the rectangle image can be generated by color sampling. In the color filtered image, the treasury seal can be recognized more easily. The way for color sample can be predefined in the best matched prototype. That is, the prototype can predefine the color filtered image as a sample sampled from the rectangle image with a group of colors selected from the following: the luminance, the chrominance, the red value, the green value, the blue value, the Y value, the Cr value, the Cb value, the hue value and so on.

If the best matched prototype does not have the information of a treasury seal, it must have a comparison result. If a comparison result between two different portions within the rectangle image matches the comparison result of the best matched prototype, the rectangle image is centrally located. Otherwise, the rectangle image is inverted. According to one embodiment of the present invention, the comparison result can be generated by the comparison between a first portion and a second portion. The binary values of the rectangle image or the binary values of the first portion and the second portion can be generated firstly. Then a specific value of each binary value within the first portion and the second portion is counted. The comparison result of the rectangle image is generated by the comparison between the sum of the counted value within the first portion and the sum of the counted value within the second portion. For examples, the counted value can be the number of 1's or 0's.

After centrally locating, one or several portion of the rectangle image can be compared with corresponding information of the best matched prototype. For examples, a specific portion of the rectangle image can be a signature, an image representing a currency value, an image representing a serial number and so on. In one embodiment of the present invention the image representing a currency value can be recognized by the HAAR wavelet transform (Wavelets for Computer Graphics Theory and Applications, p. 43-p. 56).

Therefore, in accordance with the previous summary, components, features and advantages of the present disclosure will become apparent to one skilled in the art from the subsequent description and the appended claims taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1A is a diagram illustrates a banknote;

FIG. 1B is a diagram illustrates a method for banknote recognition in the prior art;

FIG. 2 depicts the flow diagram according the method of one embodiment of the present invention;

FIG. 3 depicts the flow diagram for selecting a best matched prototype in FIG. 2;

FIG. 4 depicts the flow diagram for log recognition in FIG. 2;

FIG. 5A and FIG. 5B depicts another flow diagram according the method of one embodiment of the present invention in FIG. 2;

FIG. 6A and FIG. 6B depict the function block diagram according the system of one embodiment of the present invention;

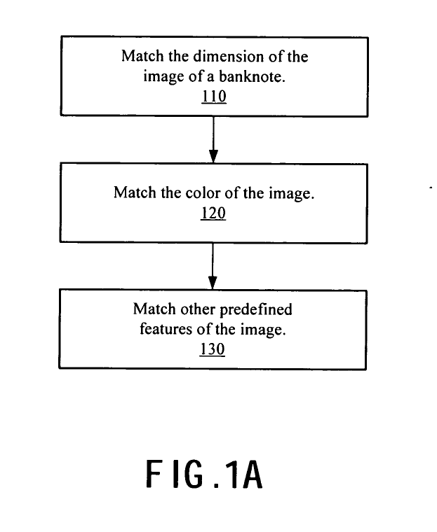

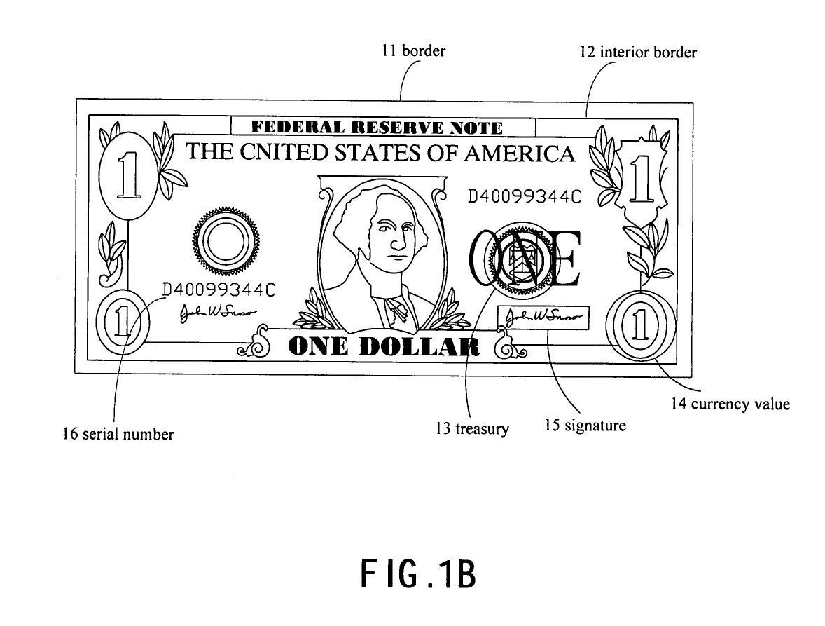

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

In the present invention, a database is predefined. There are a plurality of prototypes in the database. Each prototype is specified as a first surface or a second surface for representing a banknote, wherein the first surface and the second surface can be the front image and the back image representing a banknote separately, or vice versa. Besides, each prototype has a set of feature values or the dimension of a banknote for being selected.

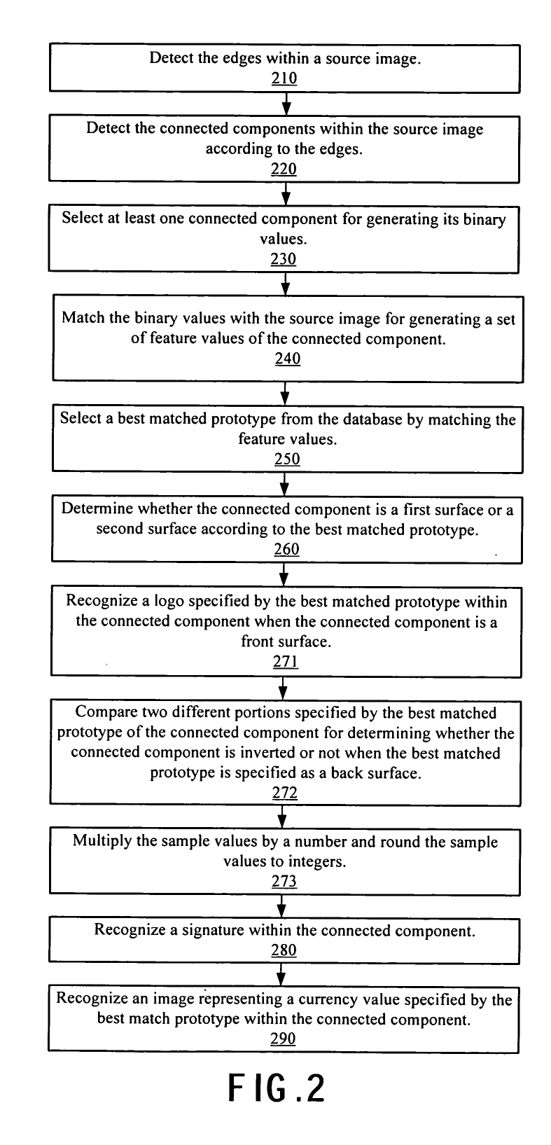

One embodiment of the present invention is a method for banknote recognition, referring to FIG. 2. Step 210 detects the edges within a source image and the step 220 detects the connected components within said source image according to the detected edges. Then step 230 selects one or several connected components for generating its binary values. Only the selected connected components will process the following steps. For each connected component, the binary values of the connected component are used to match with the source image for generating a set of feature values of the connected component, referring to step 240. Next, step 250 selecting a best matched prototype from the database by matching the feature values. Therefore, step 260 determines whether the connected component is a first surface or a second surface according to the best matched prototype. If the connected component is a first surface, then step 271 recognizes a treasury seal specified by the best matched prototype within the connected component. With the treasury seal recognition, the connected component can be determined whether it is inverted or not. Otherwise, step 272 compares two different portions specified by the best matched prototype of the connected component for determining whether the connected component is inverted or not. Furthermore, step 273 rotates the connected component through a 180 degree rotation if the connected component is inverted. Moreover, step 290 recognizes an image representing a currency value specified by the best match prototype within the connected component.

Furthermore, the embodiment of the present invention further comprises recognizing a signature within the connected component, referring to step 280. The recognition of the signature can be performed only if the connected component is the first surface or the second surface.

In step 210, the source image can be converted into a gray level image for edge detection. The edge detection can apply the Sobel method (Digital Image Processing, p. 572-p. 580), LoG method (Digital Image Processing, p. 581-p. 585), Prewitt method (Digital Image Processing, p. 572-p. 580) and so on. With the detected edges, the connected components can be detected by the connected component method (Computer and Robot Vision Voulume1, p. 28-p. 33). The detected edges could be the edges of the border or the interior border of a banknote. One skilled in the art can realize the detail for detecting the edges and the connected components, thus the present invention does not discuss the details. According to one embodiment of the present invention, the connected components which specify a rectangle region of the source image are selected for advanced recognition.

After retrieving, the rectangle image is configured within a two-dimension space. The rectangle image could be oblique in proportion to the axis. Besides, it could be inverted. Thus, the position and direction of the rectangle image can be determined before recognition. That is, the rectangle image needs to be rotated and centrally located. There could be an included angle between the axis and the edges of the rectangle image. Therefore the rectangle image should be rotated through the included angle.

The information of the pixels contains the luminance, the chrominance, the red value, the green value, the blue value, the Y value, the Cr value, the Cb value, the hue value and so on. Each value of the information can be extracted to be a sample value or a part of a sample value. The comparison of full information of all pixels will cost a lot of time. Considering the performance, the selection of the best matched set must be efficient. Thus the present invention applies partial information of the pixels within the connected component for generating the feature values. In step 230 and step 240, the feature values can be generated according to the sample which is sampled as a set selected from the group of the following: the luminance, the chrominance, the red value, the green value, the blue value, the Y value, the Cr value, the Cb value, the hue value and so on. According to one embodiment of the present invention, the hue value of HSI (Computer and Robot Vision Voulume1, p. 295-p. 302) ( [symbol] ) is preferred.

According to one embodiment of the present invention, the best matched set is selected by the comparison of the standard deviations between the feature values of the connected component and the prototypes the database. The prototypes may be filtered according to the dimension ahead of the selection of the best matched prototype. Each value of the feature values can be the number of an identical sample value. Therefore the standard deviation of each prototype can be generated according to the number of each identical sample value.

According to another embodiment of the present invention, the sample value can be reduced to an integer before the generation of the feature values. For examples, each sample can be multiplied by a number, ex. 100, and rounded.

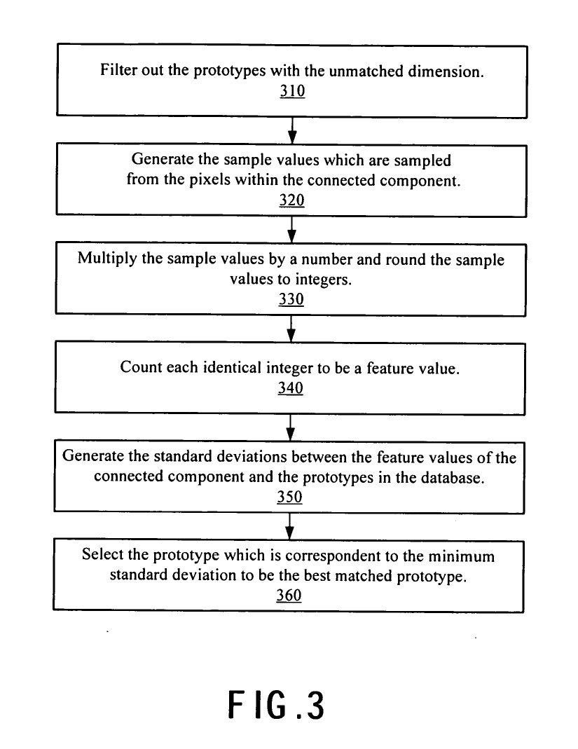

For examples, referring to FIG. 3, step 320 generates the sample values which are sampled from the pixels within the connected component. Furthermore, referring to step 330 the sample values can be multiplied by a number and rounded to be reduced to integers. Then the step 340 counts each identical integer to be a feature value. Step 350 generates the standard deviations between the feature values of the connected component and the prototypes in the database. Finally, step 360 selects the prototype which is correspondent to the minimum standard deviation to be the best matched prototype. Moreover, the example further comprises filtering out the prototypes with the unmatched dimension, referring to 310.

In step 280 and step 290, the specific locations where presenting the signature and the currency value will be recognized. Therefore the connected component should be centrally located. Namely, the coordinates of the connected component and the best matched prototype must be the same. Before centrally located, the connected component could be oblique in proportion to the axis. Besides, it could be inverted. In one embodiment of the present invention the image representing a currency value can be recognized by the HAAR wavelet method (Wavelets for Computer Graphics Theory and Applications, p. 43-p. 56).

Step 271 and step 272 is performed for determining whether the connected component is inverted or not. The step 271 and step 272 can be mutual exclusive. For examples, if the best matched prototype is specified as a first surface in step 260, step 271 is performed. Otherwise, the step 272 is performed.

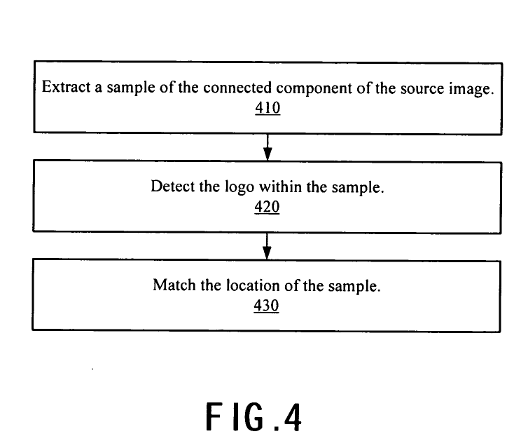

According to one embodiment of the present invention, a method of the treasury seal recognition is provided, referring to FIG. 4. The step 410 extracts a sample of the connected component of the source image. Then the step 420 detects the treasury seal within the sample. Finally, step 430 matches the location of the sample. When the treasury seal is detected and it locates on a predefined location specified by the best matched prototype, the connected component is not inverted. If the treasury seal locates on an inverted location of the predefined location, the connected component is inverted and needs to be rotated through a 180 degree rotation. The sample can be sampled as a set selected from the group of the following: the luminance, the chrominance, the red value, the green value, the blue value, the Y value, the Cr value, the Cb value, the hue value and so on. According to one embodiment of the present invention, the predefined locations of the treasury seal and the signature are on the right side of the first surface. Besides, the sample of the Cr value is preferred.

In the step 272, the different portions can be a first portion and a second portion specified by the best matched prototype. According to one embodiment of the present invention, the first portion and the second portion defines the location and the numbers of pixels with a specific color of two different areas. The comparison result is whether the number of the first portion is bigger than the number of the second portion or not. According to one embodiment of the present invention, the connected component is reduced to the binary values and the specific color can be 1's or 0's. If the comparison result of the connected component matches the comparison result specified by the best matched prototype, the connected component is not inverted, and vice versa. According to another embodiment of the present invention, the best matched prototype only specified the comparison result and the first portion and the second portion are the upper half and lower half of the connected component.

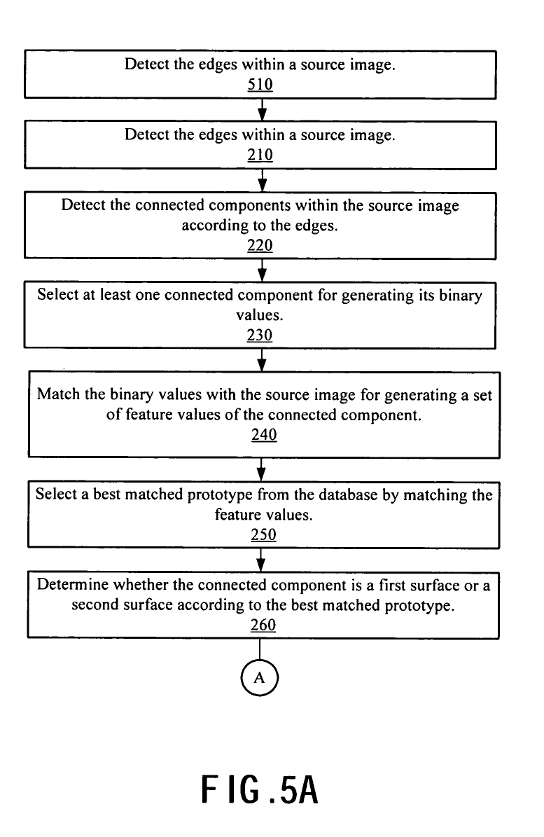

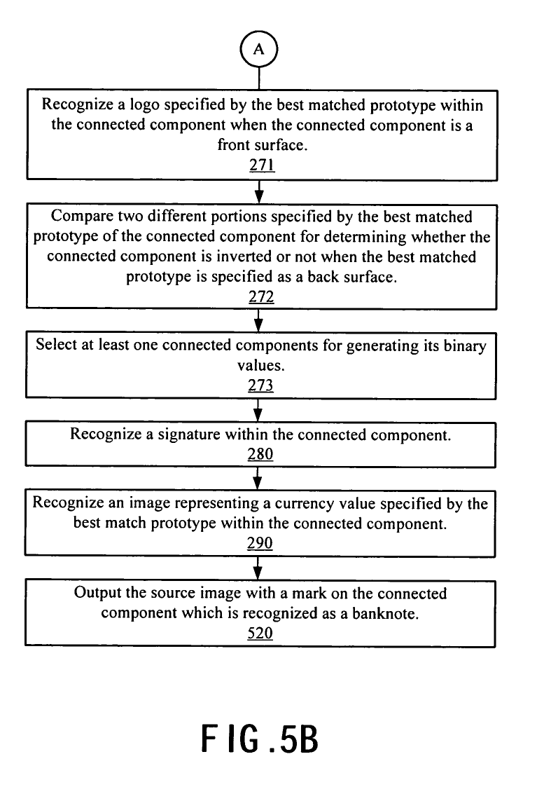

Referring to FIG. 5A and FIG. 5B, the embodiment can further comprises scanning an object to generate a source image, referring to step 510. Besides, the embodiment can further comprises outputting the source image with a mark on the connected component which is recognized as a banknote, referring to step 520.

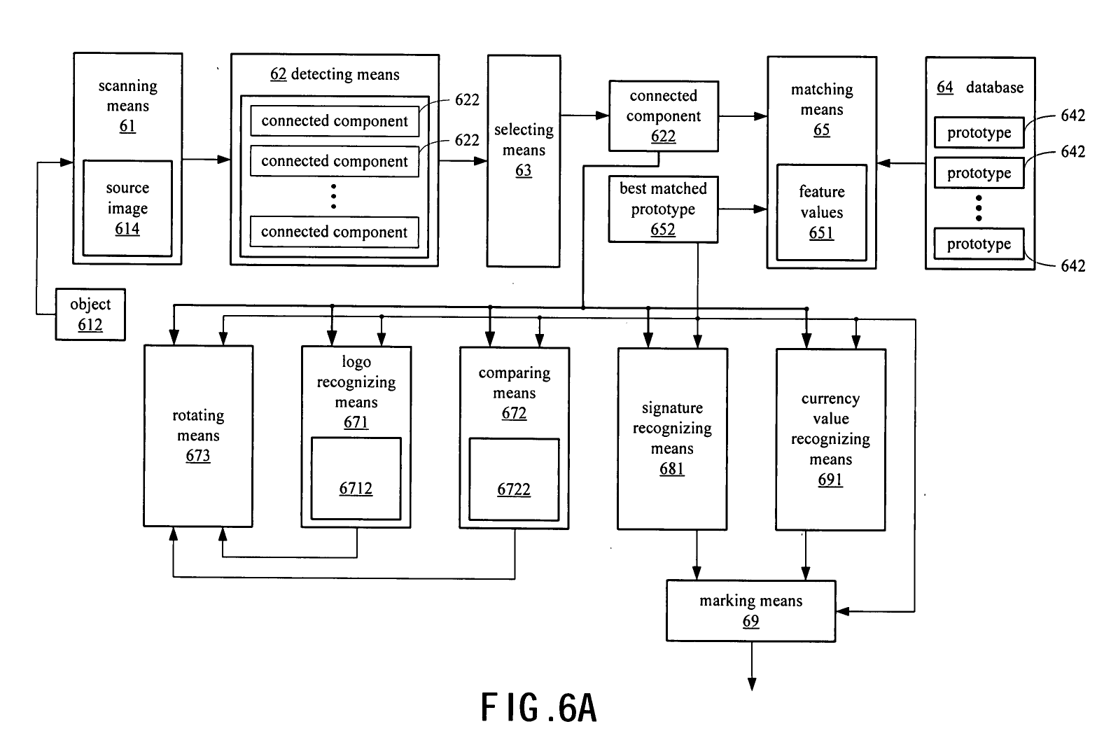

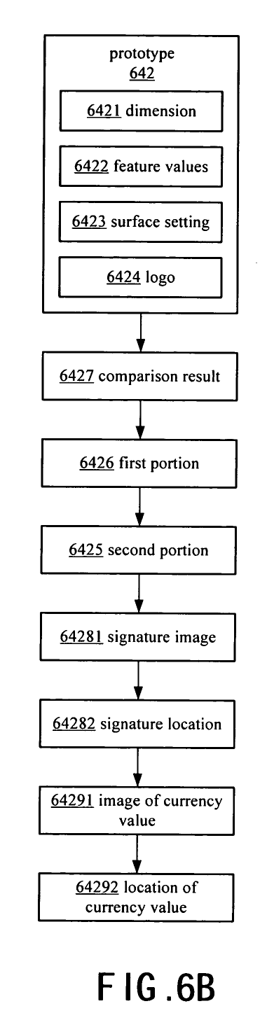

Accordingly, one embodiment of the present invention provides a system for banknote recognition, referring to FIG. 6A and FIG. 6B. The embodiment comprises a scanning means 61, a detecting means 62, a selecting means 63, a database 64, a matching means 65, a treasury seal recognizing means 671, a comparing means 672, a rotating means 673, a signature recognizing means 681, a currency value recognizing means 682, and a marking means 69.

The scanning means 61 is used for scanning an object 612 to generate a source image 614 according to above-mentioned step 510. The scanning means 61 can be configured on a scanner, a fax, a Xerox machine, a photocopier and so on.

The detecting means 62 receives the source image 614 and detects the connected components 622 within the source image 614 according to the above-mentioned step 210 and step 220. The connected components 622 are detected by the edges detected in the step 220.

The selecting means 63 selects at least one of the connected components 622 according to above-mentioned step 240. There may be a plurality of connected components 622. The selecting means 63 can select some or all of them one by one. Besides, the selecting means 63 can filter out some connected components 622 according the dimension 6421 of the prototypes 642 in the above-mentioned database 64.

The matching means 65 generates a set of feature values according to step 240 and selects a best matched prototype 652 from the database by matching the feature values 651 with the feature values 6422 of the prototypes 642 according to step 250. According to the above-mention step 260, the connected component 622 can be determined whether it is a first surface or a second surface according to the surface setting 6423 of the best matched prototype 652.

The treasury seal recognizing means 671 recognizes a treasury seal 6424 specified by the best matched prototype 652 within the connected component 622 according the above-mentioned step 271. A sample 6712 can be extracted from the connected component 622 for recognizing the treasury seal 6424. According to FIG. 4, the sample 6712 can be sampled as a set selected from the group of the following: the luminance, the chrominance, the red value, the green value, the blue value, the Y value, the Cr value, the Cb value, the hue value and so on. Furthermore, the treasury seal recognizing means 671 also determines the location of the treasury seal 6424 within the connected component 622. Therefore the connected component can be determined whether it is inverted or not.

According to the step 272, the comparing means 672 compares two different portions specified by the best matched prototype 652 of the connected component 622 for determining whether the connected component 622 is inverted or not. The different portions can be the above-mentioned first portion 6425 and second portion 6426 specified by the best matched prototype 652. Besides, the comparison result 6427 between the first portion 6425 and the second portion 6426 is also specified by the best matched prototype. According to one embodiment of the present invention, the best matched prototype can only specify the comparison result 6427 without specifying the first portion 6425 and the second portion 6426. In this case, the first portion and the second portion are the upper half and the lower half of the connected component. When the comparison result 6722 of the connected component 622 matches the comparison result 6427 of the best matched prototype 652, the connected component is not inverted. Otherwise, it is inverted.

According to the treasury seal recognizing means 671 or the comparing means 672, the rotating means 673 can determine whether the connected component 622 is inverted or not. When the connected component 622 is inverted, the rotating means rotate the connected component 622 through a 180 degree rotation according to the above-mentioned step 273.

The signature recognizing means 281 recognizes a signature specified by the signature image 64281 and the location 64282 of the best matched prototype according to step 280. If the signature is not recognized, the connected component is not a banknote.

The currency value recognizing means 282 recognizes the currency value specified by the image of the currency value 64291 and the location 64292 of the best matched prototype according to step 290. If the currency value is not recognized, the connected component is not a banknote. According to one embodiment of the present invention, the connected component is a banknote when the signature and the currency value are recognized. According to another embodiment of the present invention, the connected component is a banknote when the currency value is recognized. One skilled in the art can realize there are many combinations of the above mentioned matches and the recognitions for determining whether the connected component is a banknote or not. The examples are used to clearly realize, but not to limit, the present invention.

According to step 520, the marking means 69 outputs the source image with a mark on the connected component which is recognized as an image representing a banknote.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A method for banknote recognition, comprising:
matching the feature values of a connected component of a source image with the feature values of a plurality of prototypes in a database for selecting a best matched prototype, wherein said best matched prototype is specified as a first surface or a second surface;
recognizing a treasury seal specified by the best matched prototype within said connected component when said best matched prototype is specified as a first surface;
recognizing an image presenting a currency value within said connected component.

2. A method for banknote recognition of claim 2, further comprising:
detecting the edges within said source images;
detecting the connected components within said source image according said edges; and
selecting at least one of said connected components for matching said prototypes.

3. A method for banknote recognition of claim 2, further comprising:
generating the binary values of said selected connected component.

4. A method for banknote recognition of claim 3, further comprising:
rotating said connected component through an angle between an edge of said connected component and an axis of a two-dimension space, wherein each of said connected component specifies a rectangle region.

5. A method for banknote recognition of claim 3, wherein the threshold for generating said binary value is between 105 and 180.

6. A method for banknote recognition of claim 3, further comprising:
counting the numbers of a specific value of said binary values within a first portion and a second portion of said source image separately when said best matched prototype is specified as a second surface;
rotating said connected component through a 180 degree rotation when said comparison result between the number of said specific value within said first portion and the number of said specific value within said second portion matches the comparison result specified by the best matched prototype.

7. A method for banknote recognition of claim 6, wherein said first portion and said second portion are the upper half and the lower half of said source image separately.

8. A method for banknote recognition of claim 1, wherein said treasury seal recognition comprises:
sampling a sample of said connected component of said source image;
detecting said treasury seal within said sample; and
matching the location of said treasury seal, wherein said treasury seal is recognized when said treasury seal is detected and locates on a predefined location specified by said best matched prototype or an inverted location of said predefined location, wherein said connected component is inverted when said treasury seal locates on said inverted location.

9. A method for banknote recognition of claim 8, wherein said sample is the Cr values of said connected component.

10. A method for banknote recognition of claim 8, wherein said predefined location of said treasury seal and said inverted location are specified within the right side and left side of said source image separately.

11. A method for banknote recognition of claim 8, further comprising:
rotating said connected component through a 180 degree rotation when said treasury seal is on said inverted location.

12. A method for banknote recognition of claim 1, further comprising:
recognizing a signature specified by said best matched prototype within said rectangle image if said best matched prototype is specified as a first surface, wherein said signature is within the right side of said connected component.

13. A method for banknote recognition of claim 1, wherein said first surface and said second surface are a front surface and a back surface representing a banknote separately.

14. A method for banknote recognition of claim 1, wherein the process for selecting said best matched prototype comprises:
generating the sample values which are sampled from the pixels within the connected component;
multiplying the sample values by a number and rounding said sample values to integers;
counting each identical integer to be a feature value;
generating the standard deviations between the feature values of the connected component and the prototypes in the database, wherein each prototype is correspondent to a standard deviation separately; and
selecting the prototype which is correspondent to the minimum standard deviation to be the best matched prototype.

15. A method for banknote recognition of claim 14, wherein said sample values are the hue values of the connected component.

16. A method for banknote recognition of claim 1, further comprising:
outputting said source image with a mark on said connected component which has an image representing said currency value is recognized.

17. A system for banknote recognition, comprising:
detecting means for receiving a source image and detecting the connected components within said source image;
selecting means for selecting at least one of said connected components for matching a plurality prototypes in a database,
wherein said selected connected components are sent to a matching means;
matching means for generating a set of feature values of a connected component when said connected component is received and selecting a best matched prototype from said database by matching said feature values with the feature values of said prototypes;
treasury seal recognizing means for recognizing a treasury seal specified by said best matched prototype within said connected component;
comparing means for comparing two different portions specified by said best matched prototype of said connected component for determining whether the connected component is inverted or not;
currency value recognizing means for recognizing a currency value specified by said best matched prototype, wherein said connected component is not an image representing a banknote when said currency value can not be recognized;

18. A system for banknote recognition of claim 17, wherein said matching means performs the following procedure for selecting said best matched prototype:
generating the sample values which are sampled from the pixels within the connected component;
multiplying the sample values by a number and rounding said sample values to integers;
counting each identical integer to be a feature value;
generating the standard deviations between the feature values of the connected component and the prototypes in the database; and selecting the prototype which is correspondent to the minimum standard deviation to be the best matched prototype.

19. A system for banknote recognition of claim 17, wherein said treasury seal recognizing means perform the following procedure for recognizing said treasury seal:
sampling a sample of said connected component of said source image;
detecting said treasury seal within said sample; and
matching the location of said treasury seal, wherein said treasury seal is recognized when said treasury seal is detected and locates on a predefined location specified by said best matched prototype or an inverted location of said predefined location, wherein said connected component is inverted when said treasury seal locates on said inverted location.

20. A system for banknote recognition of claim 17, wherein said performing means perform the following procedure for recognizing said treasury seal:
generating the binary values of said connected component; and
counting the numbers of a specific value of said binary values within a first portion and a second portion of said source image separately when said best matched prototype is specified as a second surface, wherein said connected component is not inverted when said comparison result between the number of said specific value within said first portion and the number of said specific value within said second portion matches the comparison result specified by the best matched prototype.

21. A system for banknote recognition of claim 1-7, further comprising:
rotating means for rotating said connected component through a 180 degree rotation when said connected component is inverted;
signature recognizing means for recognizing a signature specified by said best matched prototype, wherein said connected component is not an image representing a banknote when said signature can not be recognized;
marking means for outputting said source image with a mark on said connected component which is recognized as a image representing a banknote.

22. A system for banknote recognition of claim 18, wherein said sample values are the hue values of the connected component.

23. A system for banknote recognition of claim 19, wherein said sample is the Cr values of said connected component.

24. A system for banknote recognition of claim 20, wherein the threshold for generating said binary value is between 105 and 180.
